(19) United States
(12) Patent Application Publication
(10) Pub. No.: US 2015/0206297 A1
(43) Pub. Date: Jul. 23, 2015

(54) Locating other people within video streams satisfying criterion with respect to selected person within streams

(71) Applicant: LENOVO ENTERPRISE SOLUTIONS (SINGAPORE) PTE.LTD., New Tech Park (SG)

(72) Inventors: Barry Alan Kritt, Raleigh, NC (US); Sarbajit Kumar Rakshit, Kolkata (IN)

(21) Appl. No.: 14/159,437

(22) Filed: Jan. 21, 2014

(51) Int. Cl. G06T 7/00; G06K 9/00

(52) U.S. Cl. CPC G06T 7/004; G06K 9/00288; G06T 2207/10016; G06T 2207/30201; G06T 2207/30232

(57) ABSTRACT

A person within a video stream is selected. Each appearance of the selected person within any video stream is located. For each appearance of the selected person, other people within the same appearance are located that each satisfy a criterion with respect to the selected person. The other people are displayed. The criterion satisfied by at least one first person of the other people includes that a facial direction of each first person converges within a first threshold with a facial direction of the person within the same appearance, such as for more than a threshold length of time. The criterion satisfied by at least one second person of the other people can include that each second person moves parallel to the selected person within a second threshold for more than a threshold length of time.

### BACKGROUND

Video cameras are commonly employed for surveillance purposes in various locations and venues. The video cameras may be permanently installed for locations like airports, train stations, and the like, where surveillance may be necessary at all times. The video cameras may be temporarily installed for short-term events where heightened surveillance is not desired all the time. Video camera surveillance can improve public safety, and assist law enforcement or other security personnel when reviewing a video record of a past occurrence is useful.

### SUMMARY

An example method includes receiving, by a computing device, selection of a person within a video stream of one or more video streams. The method includes locating, by the computing device, each appearance of one or more appearances of the person within any of the video streams. The method includes, for each appearance of the person, locating, by the computing device, one or more other people within a same appearance as the person. Each other person satisfies a criterion with respect to the person. The method includes displaying, by the computing device, the other people. The criterion satisfied by at least one first person of the other people includes a facial direction of each first person converging within a first threshold with a facial direction of the person within the same appearance.

An example computer program product includes a storage device storing computer-executable code executed by a computing device to perform a method. The method includes locating each appearance of one or more appearances of a selected person within any of one or more video streams. The method includes, for each appearance of the selected person, locating one or more other people within a same appearance. Each other person satisfies a criterion with respect to the selected person. The method includes sorting the other people in a display order according to a display order parameter, and displaying the other people in the display order. The criterion satisfied by at least one first person of the other people includes a facial direction of each first person converging within a first threshold with a facial direction of the selected person within the same appearance.

An example system includes one or more video cameras to capture one or more video streams including one or more appearances of a selected person and one or more other people. Each other person satisfies a criterion with respect to the selected person. The system includes a processor, and a storage device storing computer-executable code executable by the processor. The system includes a module implemented by the computer-executable code to locate each appearance of the selected person, locate the other people, and display the other people. The criterion satisfied by at least one first person of the other people includes a facial direction of each first person converging within a first threshold with a facial direction of the person within the same appearance for more than a threshold length of time.

### BRIEF DESCRIPTION OF THE SEVERAL VIEWS OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 is a flowchart of an example method.

FIGS. 2, 3, 4, 5, and 6, are diagrams illustratively depicting example performance of the method of FIG. 1.

FIG. 7 is a diagram of an example system in relation to which the method of FIG. 1 can be implemented or otherwise performed.

### DETAILED DESCRIPTION

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure.

As noted in the background section, video cameras are commonly employed for surveillance to assist law enforcement and other personnel to permit review of a video record of a past occurrence. A user may identify a selected person of interest within a video stream the video streams recorded by the video cameras. Existing technology may permit the user to locate the selected person within other of the video streams after the user has selected this person of interest.

However, the user may want to learn additional information regarding the selected person. For instance, locating and even identifying any other people in the video streams who may have seen the selected person can be useful. The selected person may have purposefully avoided looking directly at the video cameras, for example, making identification of who the selected person is difficult, particularly in an automated manner. Other people who may have seen the selected person may be able to provide more information as to what the selected person looks like, and further may be able to provide details regarding what the selected person did on or off camera, and so on.

Techniques disclosed herein thus locate other people that appear with a selected person within video streams and who particularly may be able to provide additional information regarding the selected person. Once a person has been selected within a video stream, each appearance of the selected person within any available video stream is located. For each such appearance, other people within the appearance in question are also located. Each of these other people satisfies a criterion with respect to the selected person, such as the facial direction thereof converging (within a threshold) with the facial direction of the selected person in the same appearance. Such other people can potentially be identified, and in any case are displayed.

By limiting the other people that are displayed to those that satisfy a criterion, large numbers of people appearing in video streams can be culled down significantly to yield a much smaller number of people who are likely to be able to provide useful information regarding the selected person. For instance, a given person whose facial direction converges with the facial direction of the selected person is more likely to have seen the face of the selected person than someone else whose facial direction did not converge with that of the selected person. As such, the user is effectively presented with an initial list of people who are most likely to be able to provide information regarding the selected person.

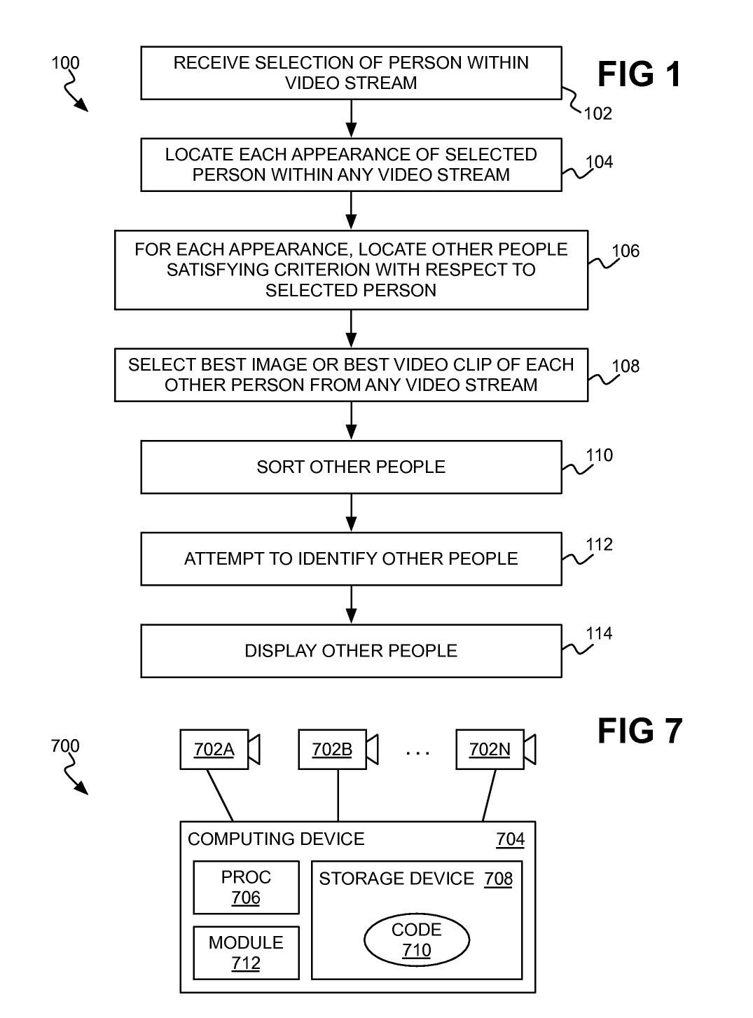

FIG. 1 shows an example method 100 to locate such other people that may be able to provide information regarding a selected person. The method 100 is performed by a computing device. For instance, the computing device may be part of a surveillance system that also includes a number of video cameras that record video streams at various places within a given location.

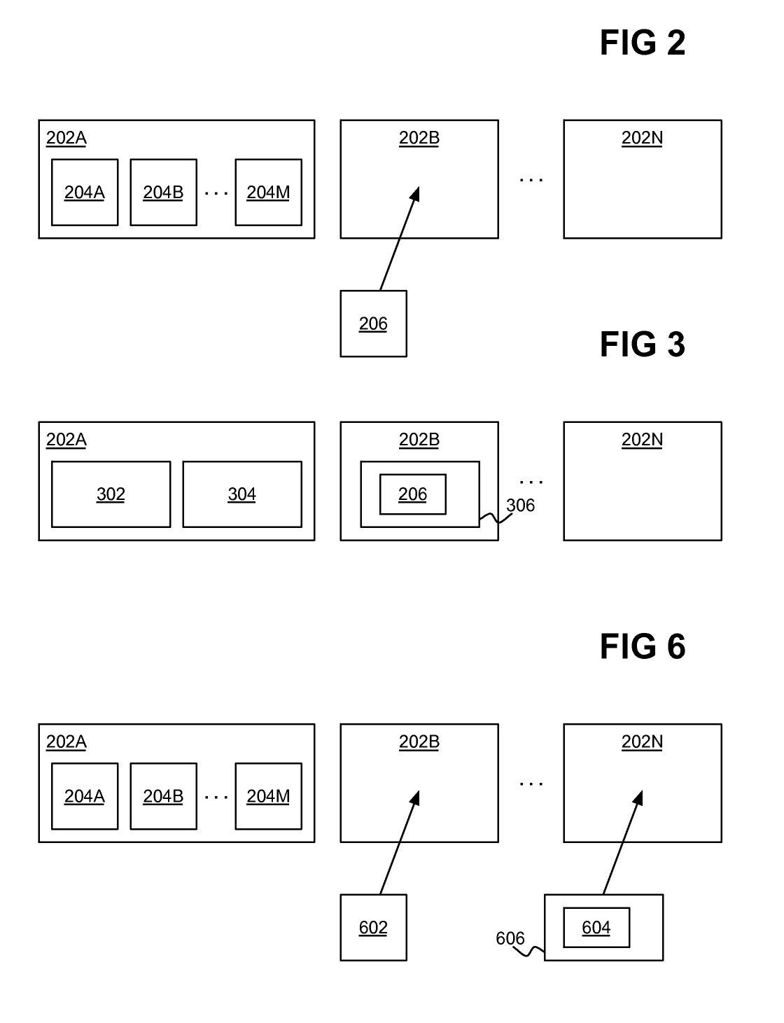

The computing device receives from a user a selection of a person within a frame of one of the video streams (102). In FIG. 2, for example, there are video streams 202A, 202B, . . . , 202N, collectively referred to as the video streams 202. Each video stream 202 includes a number of frames that in succession define the video stream 202 in question. For instance, the video stream 202A includes frames 204A, 204B, . . . , 204M, which are collectively referred to as the frames 204. A succession of the frames of a video stream 202 less than all of the frames thereof is referred to herein as a video clip, or a video stream segment. In FIG. 2, the user has selected a person within the frame 206 of the video stream 202B.

The computing device locates each appearance of the selected person within any video stream (104). Existing image analysis techniques can be employed in this respect. An appearance of the selected person is defined as one or more frames in succession in which the selected person has been recorded. A given video stream can include none, one, or more than one appearance of the selected person, for as brief as one frame in duration. Thus, locating each appearance of the selected person within any video stream includes identifying one or more frames of any video stream in which the selected person appears.

In FIG. 3, for example, there are three appearances 302, 304, and 306 of the selected person within the video streams 202. The appearances 302 and 304 each include one or more successive frames within the video stream 202A. The appearance 306 includes one or more successive frames within the video stream 202B, including the frame 206 in which the person in question was selected by the user. The video stream 202N does not include any appearances of the selected person.

It is noted, therefore, that while the user selected the person in the video stream 202B, particularly in the frame 206 thereof, the appearances 302, 304, and 306 of the selected person include more than just this frame 206 and more than of just the video stream 202B. Rather, the appearances 302, 304, and 306 also include the appearances 302 and 304 of the video stream 202A that was not used to select the person. Further, the appearances 302, 304, and 306 include the appearance 306 that may include more frames of the video stream 202B than just the frame 206 that was used to select the person. The frame 206 that was used to select the person will be a part of the appearances 302, 304, and 306 of the selected person, however.

Once each appearance in which the selected person appears has been located in part 104, the computing device performing the method 100 locates, for each appearance, other people (if any) that satisfy a criterion with respect to the selected person (106). Existing image analysis techniques can be employed to locate the other people in each appearance, and then to determine which of these other people satisfy a criterion. Two examples of criteria are presented herein, but other criteria can also be used.

FIG. 4 illustratively shows an example of a first criterion. This criterion is that the facial direction of a given person converges within a threshold with the facial direction of the selected person within the same appearance, such as for more than a threshold length of time, where the given person is proximate to the selected person for more than the same or different threshold length of time. In FIG. 4, the appearance 302 includes a selected person 402, as well as people 404, 406, and 408. The appearance 302 is particularly from the video stream 202A that may record the people 402, 404, 406, and 408 from overhead, but other video streams that record people more directly can be used as well.

Consider the person 404 in relation to the selected person 402. The selected person 402 is looking in a northeasterly direction; that is, the facial direction of the selected person is northeast. The person 404 is looking in a westerly direction; that is, the facial direction of the person 404 is west. The person 404 is not directly looking at the selected person 402, and vice-versa; that is, the facial directions of the people 402 and 404 are not directly opposite one another. However, the facial direction of the person 404 nevertheless converges within some threshold with the facial direction of the selected person 202. For instance, as depicted in FIG. 4, there is a likelihood that the person 404 saw the selected person 402.

Therefore, the threshold governing facial direction convergence can be deemed as that in which there is a likelihood of more than a predetermined percentage that a person saw a selected person. As such, the person 404 is selected as satisfying the criterion, so long as the facial direction of the person 404 converged within the threshold with that of the selected person 402 by more than a threshold length of time. It is further noted that the person 404 is proximate to the selected person 402, and is assumed for the example of FIG. 4 to have been so proximate for the same or different threshold length of time.

Consider next the person 406 in relation to the selected person 402. The person 406 is looking in a southwesterly direction; that is, the facial direction of the person 406 is southwest. Therefore, the facial directions of the people 402 and 406 are more opposite one another than the facial directions of the people 402 and 404 are, such that the facial direction of the person 406 converges within the threshold with the selected person 402 more than the facial direction of the person 404 does. However, the field of view of the appearance 302 may be such that the person 406 is located a long distance away (i.e., more than a threshold distance), and thus the person 406 is not deemed as being proximate to the selected person 402. Therefore, the person 406 is not selected as satisfying the criterion.

Consider finally the person 408 in relation to the selected person 402. The person 408 is looking in a north to northwesterly direction; that is, the facial direction of the person 408 is north to northwest. Therefore, the likelihood that the person 408 saw the selected person 402 is low. Stated another way, the facial direction of the person 408 does not converge with the facial direction of the selected person 402 within the threshold. As such, the person 408 is also not selected as satisfying the criterion.

It is noted that the image analysis that has been described in relation to the appearance 302 assumed to some degree a static analysis of the appearance 302. However, in actuality, the analysis will likely be dynamic if the appearance 302 extends for more than one frame. That is, in a given appearance, each person is likely to be moving to some degree, twisting his or her head to some degree, and so on. Dynamic analysis means that the motion of such an appearance is considered when determining whether the criterion has been satisfied.

FIG. 5 illustratively shows an example of a second criterion. This criterion is that a given person moves parallel to the selected person within a threshold, such as for more than a threshold length of time, where the given person is proximate to the selected person for more than the same or different threshold length of time. In FIG. 5, the appearance 306 includes the selected person 402, as well as people 504, 508, and 512. The appearance 306 is particularly from the video stream 202B that also records the people 402, 504, 508, and 512 from overhead, but other video streams that record people more directly can be used as well.

Consider the person 504 in relation to the selected person 402. In the appearance 306, the selected person 402 is moving as indicated by the arrow 502, whereas the person 504 is moving as indicated by the arrow 506. The person 504 is not moving completely parallel to the selected person 402. However, the person 504 in the direction in which he or she is moving is likely to have seen the selected person 402. Therefore, the person 504 is moving parallel to the selected person 402 within some threshold (i.e., parallel within a predetermined percentage) that is informed by whether a person is likely to have seen the selected person 402. The person 504 is thus selected as satisfying the criterion, so long as the person 504 was moving parallel to the selected person 402 by more than a threshold length of time. It is further noted that the person 504 is considered proximate to the selected person 402, and is assumed for the example of FIG. 5 to have been so proximate for the same or different threshold length of time.

Consider next the person 508 in relation to the selected person 402. The person 508 is moving as indicated by the arrow 510. As such, the person 508 is moving nearly completely if not completely parallel to the selected person 402. However, the field of view of the appearance 306 may be such that the person 508 is located a long distance away (i.e., more than a threshold distance), and thus the person 508 is not deemed as being proximate to the selected person 402. Therefore, the person 508 is not selected as satisfying the criterion.

Consider finally the person 512 in relation to the selected person 402. The person 508 is moving as indicated by the arrow 514. The person 508 is thus moving less parallel to the selected person 402 than the person 504 is moving in relation to the selected person 402. Therefore, as to the threshold that has been described, it is presumed that the person 512 is not moving parallel to the selected person 402 within this threshold. As such, the person 512 is also not selected as satisfying the criterion.

In both of the criteria described in relation to FIGS. 4 and 5, one person has been selected in an appearance. However, in general, more than one person can be selected in an appearance. Similarly, no people may be selected in an appearance. Each criterion that is used is applied to each appearance in an attempt to locate one or more people that satisfy any criterion.

Once the other people that satisfy any criterion with respect to the selected person in any appearance have been located in part 106, the computing device performing the method 100 selects the best image or best video clip of each such other person from any video stream (108). The computing device first determines the frames of the video streams in which a given such person appears, such as by using an existing image analysis technique as in part 104, and then determines which frame represents the best image or which successive frames represent the best video clip of this person. This can also be achieved using an existing image analysis technique.

For instance, the best image of a person may be selected as that which most clearly shows the face of the person directly. The best video clip of a person may be selected if more than one successive frame clearly show the face of the person directly. A video clip may alternatively be selected as a predetermined number of frames around the frame that shows the best image of the person, where these frames still include the person to some degree.

For example, in FIG. 6, the best image of the person 402 may be within the frame 602 that is part of the video stream 202B, and the frame 602 is thus selected as the best image of the person 402. As another example, the best image of the person 504 may be the frame 604 that is part of the video stream 202N, and a series of frames 606 including the frame 604 selected as the best video clip of the person 504. It is noted in this respect that the best image of the person 404 is not one in which the person 404 appears with the selected person 402, which is in the appearance 302 of the video stream 202A. Similarly, the best video clip of the person 504 is not one in which the person 504 appears with the selected person 402, which is in the appearance 306 of the video stream 202B. In general, then, the best image or the best video clip of a person may or may not be part of the appearance in which the person appeared with the selected person.

Once the best image or video clip of each other person has been selected in part 108, the computing device performing the method 100 sorts these people in a display order according to a display order parameter (110). The display order specifies the order in which the other people will be displayed to the user operating the computing device and that selected the person of interest in part 102. The display order parameter governs how this display order is determined.

One display order parameter is to sort the other people by the lengths of time in which they satisfied a criterion in relation to the selected person. For instance, people who satisfied a criterion for a longer period of time may be more likely to remember seeing the selected person, and may be more likely to have actually seen the selected person, and thus may be able to provide more information than people who did not satisfy a criterion for a shorter period of time. Another display order parameter is to sort the other people chronologically, from most recently to least recently with regards to when they most recently satisfied a criterion with respect to the selected person. For instance, people who satisfied a criterion more recently may be more likely to recall seeing the selected person than people who satisfied a criterion less recently. Other display order parameters can also be employed to govern the display order in which the other people are sorted.

Once the other people have been sorted in part 110, the computing device performing the method 100 attempts to identify each such person (112). Existing image analysis techniques can be used, for instance, to determine if the best image or the best video clip of a person matches any known or identified people within a database, such as by employing facial detection. Identification of a person aids the user in contacting the person to learn what he or she knows, if anything, regarding the interaction the person may have had with the selected person, because learning the identification of the person—such as his or her name and contact information—permits the user with the information needed to contact the person.

The computing device performing the method 100 then displays the other people in the display order that has been determined (114). Specifically, the best image or video clip of each person may be superimposed in the display order on or around an image of the selected person, such as the frame of the video clip in which the selected person was selected in part 102 by the user. Video clips may not be automatically played back until the user selects them. Any people that have been identified may have their identification displayed alongside their best images or video clips. Time stamps of the best images or video clips may also be displayed.

As such, the method 100 permits a user to retrieve a list of other people who are most likely to be able to provide information regarding a selected person. After the user has selected the person of interest, and until the user is presented with the list of the other people who are most likely to be able to provided information regarding the selected person, the process does not require the user's interaction. This is advantageous, because manual video review would otherwise be laborious and time-consuming, particularly when there are large amounts of video streams that would otherwise require manual review. Instead, the method 100 bootstraps existing image analysis techniques in a novel way to locate relevant people and show them to the user.

In one implementation, the location where each other person has seen the selected person can be plotted on a map displayed to the user. In one implementation, the travel path of each other person and/or the selected person is also plotted on the map displayed to the user. The user can thus glean additional information about who has seen the selected person, as well as about the selected person, in this way.

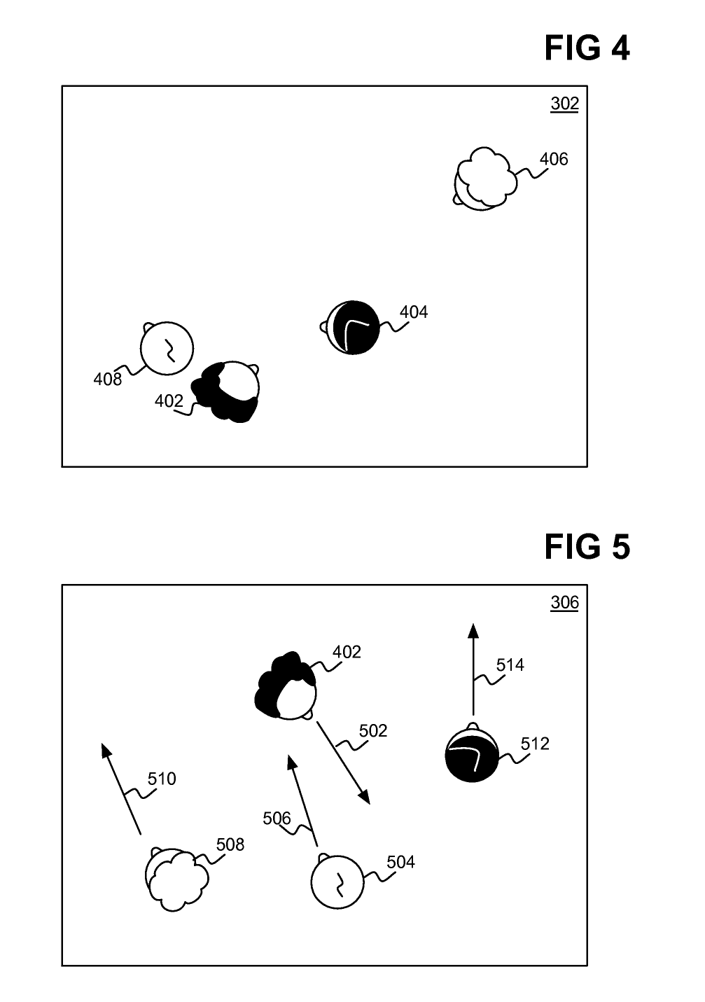

FIG. 7 shows an example system 700 that can implement the method 100 that has been described. The system 700 includes a number of video cameras 702A, 702B, . . . , 702N, which are collectively referred to as the video cameras 702, and which capture the video streams 202 that have been described. The system 700 includes a computing device 704 that may be communicatively connected to the video cameras 702 to receive the video streams 202, or the computing device 704 may receive the streams 202 in another way, such as by accessing the video streams 202 from a storage device on which the cameras 702 stored them.

The computing device 704 may be a general-purpose computing device, like a laptop or desktop computer, and so on. The computing device 704 includes at least a processor 706 and a storage device 708. The storage device 708 stores computer-executable code that is executable by the processor 706 to implement a module 712. The module 712 performs the method 100 that has been described to locate people within the video streams 202 that may be able to provide further information regarding a selected person within the video streams 202.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim:

1. A method comprising:
receiving, by a computing device, selection of a person within a video stream of one or more video streams;
locating, by the computing device, each appearance of one or more appearances of the person within any of the video streams;
for each appearance of the person, locating, by the computing device, one or more other people within a same appearance as the person, each other person satisfying a criterion with respect to the person; and
displaying, by the computing device, the other people,
wherein the criterion satisfied by at least one first person of the other people comprises a facial direction of each first person converging within a first threshold with a facial direction of the person within the same appearance.

2. The method of claim 1, wherein receiving the selection of the person within the video stream comprises receiving the selection of the person from a user.

3. The method of claim 1, wherein locating each appearance of the person comprises identifying one or more frames of any of the video streams in which the person appears.

4. The method of claim 1, wherein the criterion satisfied by the at least one first person further comprises the facial direction of each first person converging within the first threshold with the facial direction of the person within the same appearance for more than a threshold length of time.

5. The method of claim 1, wherein the criterion satisfied by the at least one first person further comprises each first person being proximate to the person for more than a threshold length of time.

6. The method of claim 1, wherein the criterion satisfied by at least one second person of the other people comprises each second person moving parallel to the person within a second threshold for more than a threshold length of time.

7. The method of claim 6, wherein the criterion satisfied by the at least one second person further comprises each second person being proximate to the person for more than another threshold length of time.

8. The method of claim 1, further comprising, prior to displaying the other people:
selecting one or more of a best image from the video streams and a best video stream segment from the video streams of each other person,
wherein displaying the other people comprises displaying the one or more of the best image and the best video stream segment of each other person.

9. The method of claim 1, further comprising, prior to displaying the other people:
determining an order in which the other people are to be displayed by lengths of time the other people satisfied the criterion with respect to the person.

10. The method of claim 1, further comprising, prior to displaying the other people:
determining an order in which the other people are to be displayed chronologically from most recently to least recently as to when the other people most recently satisfied the criterion with respect to the person.

11. The method of claim 1, further comprising, prior to displaying the other people:
attempting to identifying each other person,
wherein displaying the other people comprises, for each other person successfully identified, displaying identification information thereof.

12. A computer program product comprising a storage device storing computer-executable code executed by a computing device to perform a method comprising:
locating each appearance of one or more appearances of a selected person within any of one or more video streams;
for each appearance of the selected person, locating one or more other people within a same appearance, each other person satisfying a criterion with respect to the selected person;
sorting the other people in a display order according to a display order parameter; and
displaying the other people in the display order,
wherein the criterion satisfied by at least one first person of the other people comprises a facial direction of each first person converging within a first threshold with a facial direction of the selected person within the same appearance.

13. The computer program product of claim 12, wherein locating each appearance of the selected person comprises identifying one or more frames of any of the video streams in which the selected person appears.

14. The computer program product of claim 12, wherein the criterion satisfied by the at least one first person further comprises:
the facial direction of each first person converging within the first threshold with the facial direction of the selected person within the same appearance for more than a threshold length of time; and
each first person being proximate to the selected person for more than another threshold length of time.

15. The computer program product of claim 12, wherein the criterion satisfied by at least one second person of the other people comprises:
each second person moving parallel to the selected person within a second threshold for more than a threshold length of time; and
each second person being proximate to the selected person for more than another threshold length of time.

16. The computer program product of claim 12, wherein the method further comprises, prior to displaying the other people:
selecting one or more of a best image from the video streams and a best video stream segment from the video streams of each other person,
wherein displaying the other people comprises displaying the one or more of the best image and the best video stream segment of each other person.

17. The computer program product of claim 12, wherein the display order parameter comprises ordering by lengths of time the other people satisfied the criterion with respect to the person.

18. The computer program product of claim 12, wherein the display order parameter comprises ordering chronologically from most recently to least recently as to when the other people most recently satisfied the criterion with respect to the person.

19. The computer program product of claim 12, wherein the method further comprises, prior to displaying the other people:
attempting to identifying each other person,
wherein displaying the other people comprises, for each other person successfully identified, displaying identification information thereof.

20. A system comprising:
one or more video cameras to capture one or more video streams including one or more appearances of a selected person and one or more other people, each other person satisfying a criterion with respect to the selected person;
a processor;
a storage device storing computer-executable code executable by the processor;
a module implemented by the computer-executable code to locate each appearance of the selected person, locate the other people, and display the other people,
wherein the criterion satisfied by at least one first person of the other people comprises a facial direction of each first person converging within a first threshold with a facial direction of the person within the same appearance for more than a threshold length of time.
